(19) United States
(12) Patent Application Publication
(10) Pub. No.: US 2007/0242051 A1
(43) Pub. Date: Oct. 18, 2007

(54) Electronic Conference System, Electronic Conference Support Method, Electronic Conference Control Apparatus, And Portable Storage Device

(75) Inventors: Kazunori Horikiri, Kanagawa (JP); Yoshiki Watanabe, Kanagawa (JP); Masatomi Inagaki, Tokyo (JP); Yoshihiro Masuda, Kanagawa (JP); Katsuya Mitsutake, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/553,494

(22) Filed: Oct. 27, 2006

(30) Foreign Application Priority Data
Apr. 14, 2006 (JP) 2006-111497

(51) Int. Cl. G06F 3/041

(52) U.S. Cl. 345/173

(57) ABSTRACT

A first conference controller that controls display of a first display includes a storage processing unit that stores in a screen image data storage a screen image displayed on the first display upon receipt of copy-instructing request from a portable storage, and a writer that sends, to the portable storage, acquisition source information regarding data of the screen image displayed on the first display in accordance with the copy-instructing request from the portable storage for storing the information in the portable storage. A second conference controller that controls display of a second display includes a reader that reads the acquisition source information stored in the portable storage, an acquisition processing unit that acquires the data from the screen image data storage on the basis of the acquisition source information, and a display controller that displays on the second display the screen image acquired by the acquisition processing unit.

### PRIORITY INFORMATION

This application claims priority from Japanese Patent Application No. 2006-111497, filed on Apr. 14, 2006. which is incorporated herein by reference in its entirety.

### BACKGROUND

1. Technical Field

The present invention relates to an electronic conference system, and more particularly to transfer of a display image performed without the complicated connection configuration of a network.

2. Related Art

Conventionally, there has been known an electronic conference system equipped with a displayable and writable large touch panel display device. The touch panel display device is typically placed at a location that is visible to all conference participants present in a conference room and is also writable for the conference participants. In addition to giving conference participants an opportunity to participate in a conference while sitting in their own chairs, utilization of such an electronic conference system can lead to implementation of a conference style in which conference participants gather around a touch panel display device and conduct a discussion while writing onto the touch panel display device ideas conceived during the conference. The content written on the touch panel display device can be stored as a screen image on an “as is” basis, which can bring efficiency to conferences. As a result, there has been a trend toward more and more companies adopting an electronic conference system, in view of enhancing efficiency of conferences.

It is also possible to hold a teleconference by means of network connection of conference control apparatuses installed in conference sites. More specifically, assuming that a conference room where a moderator is present is taken as a host site, screen images displayed on a touch panel display device placed at the host site are stored in a predetermined data management server and distributed to other sites in real time, which allows the other sites to participate in a discussion about a common subject while referencing the same display content as that displayed at the host site.

As described above, the content displayed on the touch panel display device is stored as a screen image in the data management server. Accordingly, when results of discussion in a conference are written in the touch panel display device, the results of discussion can be transformed into screen image data and retained and managed in the data management server.

Such results of discussion in the conference might include information useful not only for a group which has held the conference but also for other groups. If it becomes possible to retrieve screen images of the results of discussion stored in the data management server according to a conventional electronic conference system, the screen images can be referenced in another conference.

### SUMMARY

An electronic conference system according to the present invention includes a first conference control apparatus that controls display of a first display device, a second conference control apparatus that controls display of a second display device, a portable storage device capable of communicating with each of the first and second conference control apparatuses, and a screen image data storage unit in which screen images displayed at least on the first display device are stored. In the electronic conference system, the first conference control apparatus includes a storage processing unit that stores in the screen image data storage unit a screen image displayed on the first display device upon receipt of copy-instructing request from the portable storage device, and a writing unit that sends to the portable storage device acquisition source information regarding data of the screen image displayed on the first display device in accordance with the copy-instructing request from the portable storage device, to thereby store the acquisition source information in the portable storage device. Further, the second conference control apparatus includes a reader that reads the acquisition source information stored in the portable storage device, an acquisition processing unit that acquires the data of the screen image from an acquisition source which can be located on the basis of the acquisition source information read by the reader, and a display controller that displays on the second display device the data of the screen image acquired by the acquisition processing unit.

### BRIEF DESCRIPTION OF THE DRAWINGS

Exemplary embodiments of the present invention will be described in detail by reference to the following figures, wherein:

FIG. 1 is a block configuration diagram showing an electronic conference system according to an exemplary embodiment of the present invention;

FIG. 2A shows a display example presented on a touch panel display device contained in the electronic conference system according to the exemplary embodiment;

FIG. 2B shows a display example presented on a PDA according to the exemplary embodiment;

FIG. 2C shows a display example presented on the PDA according to the exemplary embodiment;

FIG. 2D shows a display example presented on the PDA according to the exemplary embodiment;

FIG. 2E shows a display example presented on a touch panel display device contained in the electronic conference system according to the exemplary embodiment; and

FIG. 3 is a communication sequence diagram showing process steps for performing copying and pasting of a screen image in the exemplary embodiment.

### DETAILED DESCRIPTION

With reference to the drawings, exemplary embodiments of the present invention will be described below.

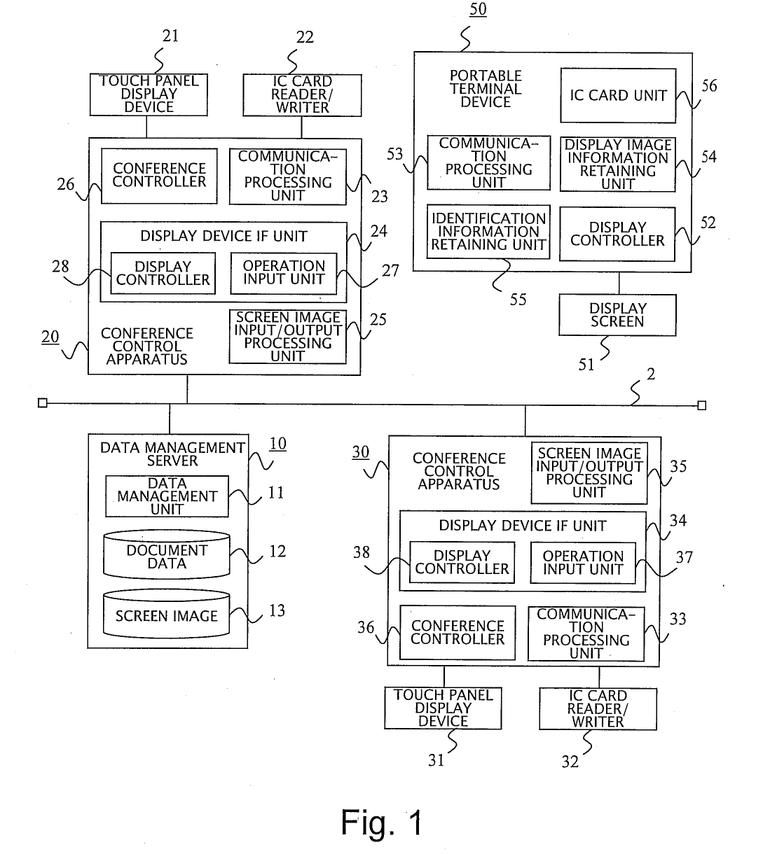

FIG. 1 is a block configuration diagram showing an electronic conference system according to an exemplary embodiment of the present invention. FIG. 1 shows a data management server 10 and conference control apparatuses 20, 30 respectively connected to a LAN 2 which is one form of network, in addition to a portable terminal device 50 carried by a conference participant. Although the portable terminal devices 50 to be provided are equal in number to conference participants, in view that the portable terminal devices 50 are individually carried by the conference participants, all the portable terminal devices 50 may have the same configuration, and only one of the portable terminal devices 50 is shown in FIG. 1.

The data management server 10 is a database server computer which retains and manages image data to be used in electronic conferences. The data management server 10 includes a document data storage unit 12 in which document data used in the electronic conferences, such as conference materials converted into an electronic form, to be displayed on touch panel display devices 21, 31 are stored. Meanwhile, screen images displayed on the touch panel display devices 21, 31 are stored in a screen image storage unit 13. In response to a request from the conference control apparatuses 20, 30, a data management unit 11 performs information management processing operations, such as registration of image data in the document data storage unit 12, readout of the image data from the document data storage unit 12, and registration of the screen images sent from the conference control apparatuses 20, 30 into the screen image storage unit 13. The data management unit 11 is implemented by collaborative operation of a computer forming the data management server 10 and a program running on a CPU mounted in the computer. Meanwhile, the document data storage unit 12 and the screen image storage unit 13 are implemented by external storage devices mounted in the data management server 10.

The conference control apparatuses 20, 30, which are client computers used for controlling a conference, are connected to peripheral devices of the touch panel display devices 21, 31 and IC card reader/writers 22, 32, respectively. In view that the conference control apparatuses 20 and 30 may have similar hardware configurations, a configuration of only the conference control apparatus 20 will be described as a representative example. The touch panel display device 21 is disposed similarly to an electronic white board, providing all participants with viewability to content displayed thereon, and displays conference materials or the like used for electronic conferences. The IC card reader/writer 22, which is typically a device for reading IC cards owned by conference participants in order to authenticate users participating in a conference, is also used as a reader for reading data stored in the portable terminal devices 50 carried by the users or a writer for writing data in the portable terminal device 50 in this exemplary embodiment. Although in the present exemplary embodiment the IC card reader/writer 22 is placed beside the touch panel display device 21 or integrated into the touch panel display device 21, the IC card reader/writer 22 may be placed at an arbitrary location.

The conference control apparatus 20 has a communication processing unit 23, a display device interface (IF) unit 24, a screen image input/output processing unit 25, and a conference controller 26. The communication processing unit 23 inputs data read from the portable terminal device 50 by the IC card reader/writer 22, and outputs data via the IC card reader/writer 22 to the portable terminal device 50. The data to be received and sent will be described below in detail. The display device IF unit 24 controls operation of the touch panel display device 21. An operation input unit 27 contained in the display device IF unit 24 detects user operation performed on the touch panel display device 21 and accepts an input, such as an instruction, note data, or the like, entered by the user operation. Further, a display controller 28 controls display of the touch panel display device 21, such as displaying of image data registered in the data management server 10 on the touch panel display device 21. The screen image input/output processing unit 25 acquires document data or screen image data to be displayed on the touch panel display device 21 from the data management server 10, or sends the screen image displayed the touch panel display device 21 to the data management server 10 for storing the screen image in the data management server 10. The conference controller 26 controls operation of the units 23 to 25 other than the conference controller 26 itself and performs overall control of an electronic conference in cooperation with other computers. The units 23 to 25 in the conference control apparatus 20 are implemented by collaborative operation of a computer forming the conference control apparatus 20 and a program running on a CPU mounted in the computer.

The portable terminal device 50 is an information device of a mobile type that the conference participants carry and bring in a conference room. In the present exemplary embodiment, the portable terminal device 50 is assumed to be a personal digital assistant (PDA). The portable terminal device 50 has a display controller 52, a communication processing unit 53, a display image information retaining unit 54, an identification information retaining unit 55, and an IC card unit 56. The display controller 52 controls display of the display screen 51. The communication processing unit 53 performs data communication with the conference control apparatuses 20, 30 via the IC card reader/writers 22, 32. More specifically, the communication processing unit 53 writes display image information sent from the conference control apparatuses 20, 30 into the display image information retaining unit 54 for storing the display image information, and sends the display image information stored in the display image information retaining unit 54 to the conference control apparatuses 20, 30. The identification information retaining unit 55 retains IP addresses as information necessary for identifying the portable terminal devices 50 and for performing inter-device communication and retains user IDs as information used for identifying owners of the portable terminal devices 50. In the present exemplary embodiment, short-range wireless communication is established between the IC card reader/writers 22, 32 and the portable terminal device 50, and the IC card unit 56 functions as a storage area for retaining data to be read by bringing the portable terminal device 50 close to the IC card reader/writers 22, 32 and accepting written data. The units 52 to 53 in the portable terminal device 50 are implemented by collaborative operation of a computer mounted in the portable terminal device 50 and a program running on a CPU mounted in the computer. The units 54 to 56 may be implemented by a nonvolatile memory such as a flash memory.

The electronic conference system according to the present invention is not necessarily limited to application in teleconferences which take place by means of remote connections of distant sites, and may be applied to conferences which are conducted by means of the touch panel display devices 21, 31 and various computers connected to a network.

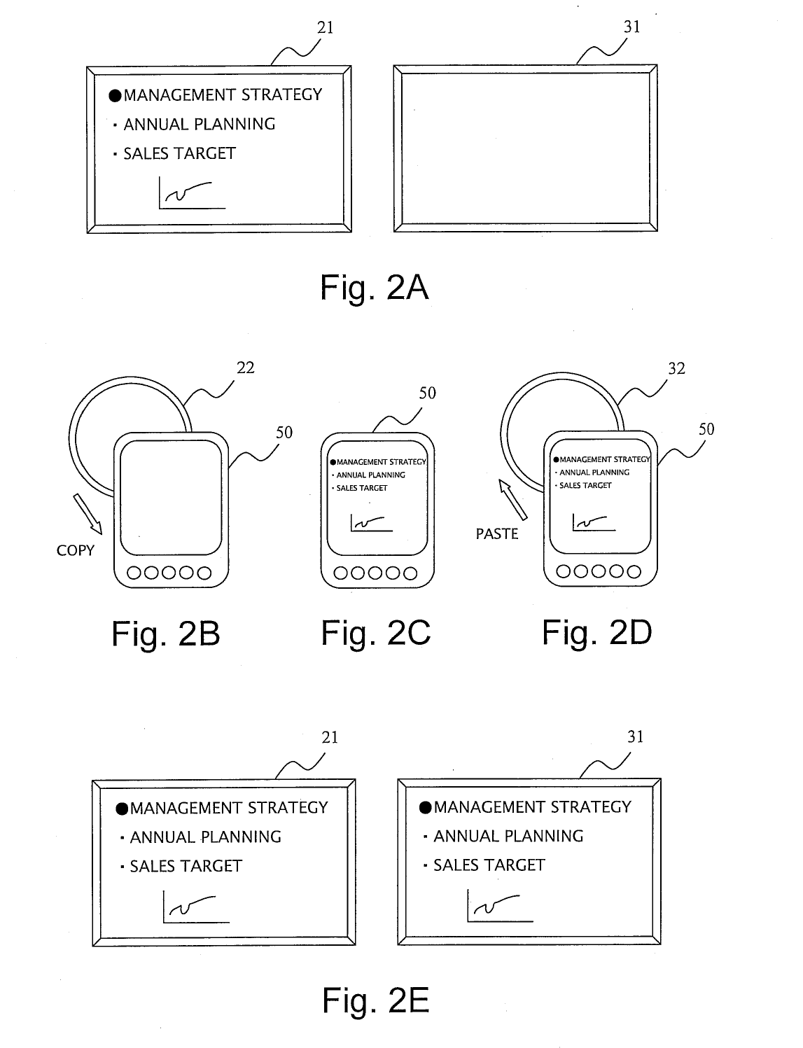

In short, the present exemplary embodiment is characterized in providing a function of copying and pasting a screen image displayed on the touch panel display device by means of the portable terminal device 50. Process steps of causing the touch panel display device 31 to display a screen image which has been displayed on the touch panel display device 21 using a copy and paste function according to the present exemplary embodiment will be described below. Referring first to FIGS. 2A to 2E, a user scene for using the present exemplary embodiment will be briefly described.

As shown in FIG. 2A, it is assumed that document data are displayed on the touch panel display device 21. It should be noted that although FIG. 2A shows the touch panel display device 31 having no data displayed thereon, the touch panel display device 31 may be in any display state at this point. Here, if a conference participant desires the other touch panel display device 31 to also display the content identical with that having been displayed on the touch panel display device 21, the conference participant moves to an installation site of the IC card reader/writer 22 located in the proximity of the touch panel display device 21, and, after inputting a predetermined copy request, brings the portable terminal device 50 near to the IC card reader/writer 22 (FIG. 2B). As a result, the content displayed on the touch panel display device 21 is copied through the IC card reader/writer 22 into the portable terminal device 50 via short-range wireless communication. In the present exemplary embodiment, a thumbnail image is generated on the basis of the screen image data displayed on the touch panel display device 21, and transferred rather than the displayed screen image data itself being transferred, in consideration of a data capacity. FIG. 2C shows a display example of the thumbnail image transferred and displayed on the portable terminal device 50. Subsequently, the conference participant moves to an installation site of the IC card reader/writer 32 located in the proximity of the touch panel display device 31 being a copy destination and brings the portable terminal device 50 close to the IC card reader/writer 32 (FIG. 2D). Before the portable terminal device 50 is brought close to the IC card reader/writer 32, a predetermined paste-instructing operation may be performed if necessary. Then, the IC card reader/writer 32 reads data from the portable terminal device 50 via short-range wireless communication. When the IC card reader/writer 32 reads the data, the conference control apparatus 30 displays on the touch panel display device 31 the screen image having been displayed on the touch panel display device 21 on the basis of the read data. Here, because the portable terminal device 50 only stores the thumbnail image, the conference control apparatus 30 must separately obtain data of the screen image to be displayed on the touch panel display device 31 from the conference control apparatus 20 or other apparatuses. The processing for obtaining the data will be described later. FIG. 2E shows a display example of the screen image displayed on the touch panel display device 31 according to the above-described user operation.

In the present exemplary embodiment, a desired screen image can easily be displayed on the other touch panel display device 31 through the use of the portable terminal device 50 as described above.

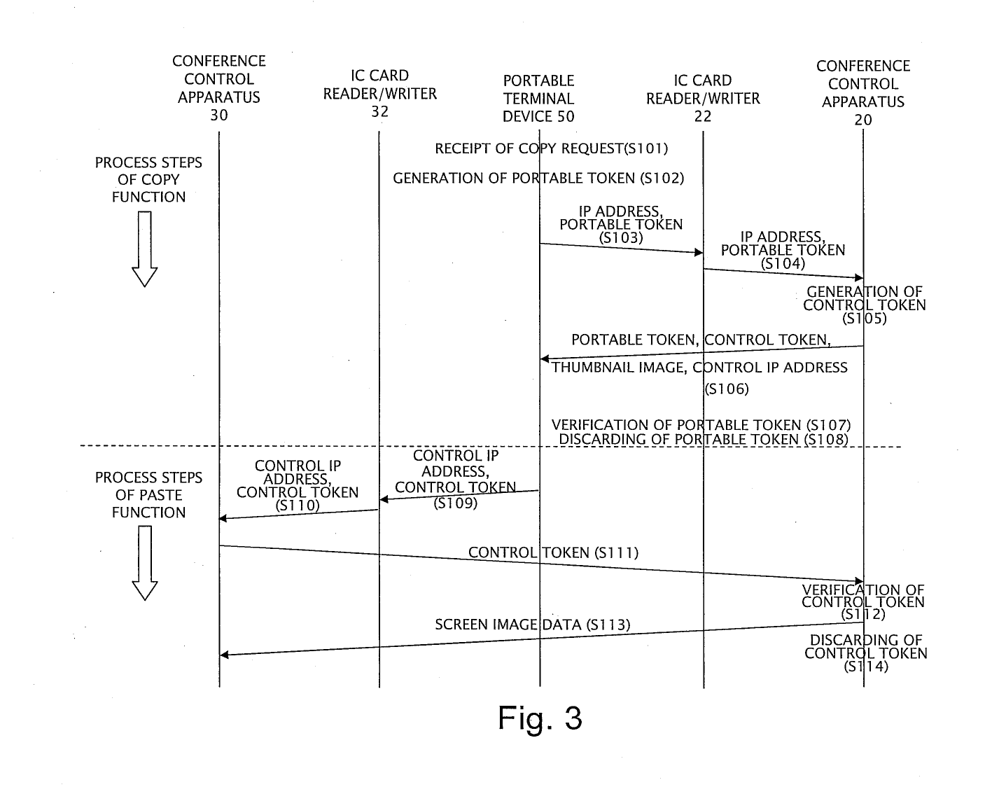

Up to this point, the present exemplary embodiment has been described from a viewpoint of the user scene. Next will be described operation of the electronic conference system which provides the copy and paste functions according to this exemplary embodiment with reference to the communication sequence diagram shown in FIG. 3.

If a conference participant wishes to reference the content displayed during a conference on the touch panel display device 21 in another conference, the conference participant inputs the predetermined copy request in the portable terminal device 50. When the portable terminal device 50 receives the input of the copy request (step 101), the communication processing unit 53 generates a new token (step 102). Then, the communication processing unit 53 writes into the IC card unit 56 the token and an IP address of the portable terminal device 50 stored in the identification information retaining unit 55. It should be noted that although in the present exemplary embodiment the IP address of the portable terminal device 50 is stored in advance in the identification information retaining unit 55, the IP address may be found and read by referencing a predetermined storage location. When the conference participant brings the portable terminal device 50 close to the IC card reader/writer 22 after completion of data writing into the IC card unit 56, the IC card reader/writer 22 reads the data; i.e. the token and the IP address stored in the IC card unit 56 (step 103). In response to the data reading, the communication processing unit 23 inputs the read data (step 104). In the present exemplary embodiment, when the read data are composed of the token and the IP address, it is determined that a copy request is issued. It is, of course, possible that explicit copy request information, such as flag information or control data, may be written along with the token and other data in the IC card unit 56 by the portable terminal device 50.

When the conference control apparatus 20 recognizes receipt of the copy request, the conference controller 26 causes the display device IF unit 24 to generate a thumbnail image for the screen image which is presently displayed while causing the screen image input/output processing unit 25 to send the screen image being displayed to the data management server 10 for storing the screen image. At this time, information about a storage destination of the screen image (for example, a URL) should be obtained from the data management server 10. The communication-processing unit 23 generates another token (step 105), and associates the generated token with the screen image. Specifically, the generated token is associated with the information about the storage destination of the screen image. Next, the communication processing unit 23 specifies the input IP address to establish a connection with the portable terminal device 50 via a wireless communication network. Then, the communication processing unit 23 sends, to the portable terminal device 50 via the IC card reader/writer 22, the input token (hereinafter referred to as a “portable token”), the token that the communication processing unit 23 has generated (hereinafter referred to as a “control token”), the IP address of the conference control apparatus 20 (hereinafter referred to as a “control IP address”), and the generated thumbnail image (step 106). The control IP address is not necessarily contained in the data to be sent, because the portable terminal device 50 can obtain the control IP address by checking attribute information of the sent data.

The communication processing unit 53 in the portable terminal device 50 checks the received portable token to thereby determine whether or not the received portable token is the valid token that the communication processing unit 53 has generated. When the validity of the received portable token is verified (step 107), the communication processing unit 53 writes and stores the received information in the display image information retaining unit 54. When, on the other hand, the received token is invalid, the communication processing unit 53 discards the received portable token and information (step 108).

Alternatively, the IC card reader/writer 22 may read the IP address of the portable terminal device 50, while the conference control apparatus 30 may generate the control token on the basis of the IP address and send the control token, the thumbnail image, and the IP address of the conference control apparatus 30 to the portable terminal device 50 when the user brings the portable terminal device 50 close to the IC card reader/writer 22. In other words, data may be transferred without the use of the portable token.

Up to this point, process steps of copy function in the present exemplary embodiment have been described. In a state as described above, the conference participant who is using the portable terminal device 50 can perform a predetermined display operation. As a result of the predetermined display operation, the display controller 52 reads the thumbnail image from the display image information retaining unit 54 and displays the thumbnail image on the display screen 51 as shown in FIG. 2C. In this manner, the conference participant can verify a screen image to be copied. Because in this exemplary embodiment the thumbnail image is generated and stored instead of the screen image itself being displayed on the touch panel display device 21, there can be prevented the situation where the storage capacity of the portable terminal device 50 is needlessly occupied by image data. Next, process steps in paste function will be described.

Firstly, the control token and the control IP address must be written in the IC card unit 56 before initiating the paste function. This may be realized by writing the control token and the control IP address in the IC card unit 56 when they are received during the process steps of the copy function, or alternatively by reading the control token and the control IP address from the display image information retaining unit 54 and writing them in the IC card unit 56 in accordance with a predetermined paste instructing operation of the conference participant. The first way is applicable in cases where the pasting is executed immediately subsequent to the copying, and where an object to be copied and pasted is only a single screen image. Meanwhile, in addition to the above cases, the alternative second way can be applied also in cases where there is a time interval between the copying and the pasting, and where multiple screen images are retained. In this regard, the second way is more versatile.

The conference participant moves to the installation site of the touch panel display device 31 on which the image stored in the portable terminal device 50 is pasted, and brings the portable terminal device 50 close to the IC card reader/writer 32. As a result, the IC card reader/writer 32 reads the data stored in the IC card unit 56; i.e., the control token and the control IP address (step 109). In response to this data reading, the communication processing unit 33 inputs the read data (step 110). It should be noted that because the thumbnail image is generated for use in display on the portable terminal device 50, there is no necessity to send the thumbnail image to the conference control apparatus 30.

Next, the communication processing unit 33 designates the input control IP address to establish connection with the conference control apparatus 20 on the wireless communication network, and presents the input control token for sending a request to transmit screen image data via the IC card reader/writer 32 to the conference control apparatus 20 (step 111).

The communication processing unit 23 in the conference control apparatus 20 examines the presented control token to determine whether or not the presented control token is the valid token that the communication processing unit 23 has generated. When validity of the control token is verified (step 112), the communication processing unit 23 obtains the screen image data associated with the control token and sends the obtained data to the conference control apparatus 30 (step 113). When the presented token is invalid, the token is discarded (step 114).

In the present exemplary embodiment, an object associated with the control token is storage destination information regarding the screen image data. Accordingly, the screen image data which is identified on the basis of the storage destination information must be obtained from the data management server 10 by the screen image input/output processing unit 25 and sent to the conference control apparatus 30. When a target screen image to be transmitted remains displayed on the touch panel display device 21, corresponding target screen image data existing in the conference control apparatus 20 are simply transmitted to the conference control apparatus 30. However, in light of the possibility that the content displayed on the touch panel display device 21 is replaced, the control token is associated with the storage destination information of the screen image data. Alternatively, a screen ID which identifies each screen image may be associated with the control token as usable information for locating the screen image.

In the conference control apparatus 30, when the communication processing unit 33 obtains the screen image data to be pasted as described above, the display controller 38 displays the obtained screen image data on the touch panel display device 31. Consequently, the screen image identical with the screen image that has been displayed on the touch panel display device 21 is displayed as shown in FIG. 2E.

Further, in the present exemplary embodiment, the IP address of the conference control apparatus 20 is used as acquisition source information necessary for acquiring the screen image data to be displayed on the conference control apparatus 30. Accordingly, the conference control apparatus 30 causes the conference control apparatus 20 to acquire the screen image data to be pasted, and receives the screen image data from the conference control apparatus 20. Meanwhile, when storage destination information regarding the screen image data to be pasted is used in place of the acquisition source information, the conference control apparatus 30 is enabled to acquire and display the screen image data by sending a transmission request containing the storage destination information to the data management server 10 without requesting the conference control apparatus 20 to acquire the screen image.

Although in the present exemplary embodiment there is described an example of the cut and paste performed in a direction from the conference control apparatus 20 to the conference control apparatus 30, data may be cut and pasted in the opposite direction, because the conference control apparatuses 20 and 30 have the same structure. When it is assumed that cut and paste operation is performed in only one direction, a conference control apparatus from which data are copied and another conference control apparatus to which the data are pasted need not have the same structure.

In the cut and paste operation which is basically performed for the purpose of enabling the conference control apparatus 30; i.e., a destination, to display the screen image identical with that having been displayed on the conference control apparatus 20; i.e., a source, the conference control apparatus 30 and the conference control apparatus 20; i.e., the destination and the source, may be one and the same display device when there is an interval between the time when data are copied in the portable terminal device 50 and the time when the data are pasted from the portable terminal device 50.

Although in the above-described exemplary embodiment data exchange between the conference control apparatuses 20, 30 and the portable terminal device 50 is performed through short-range wireless communication, the data exchange may be realized through wired connection.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic conference system comprising:
a first conference control apparatus that controls display of a first display device;
a second conference control apparatus that controls display of a second display device;
a portable storage device capable of communicating with each of the first and second conference control apparatuses; and
a screen image data storage unit in which screen images displayed at least on the fist display device are stored,
wherein the first conference control apparatus comprises
a storage processing unit that stores in the screen image data storage unit a screen image displayed on the first display device upon receipt of copy-instructing request from the portable storage device, and
a writing unit that sends to the portable storage device acquisition source information regarding data of the screen image displayed on the first display device in accordance with the copy-instructing request from the portable storage device, to thereby store the acquisition source information in the portable storage device, and
wherein the second conference control apparatus comprises
a reader that reads the acquisition source information stored in the portable storage device,
an acquisition processing unit that acquires the data of the screen image from the screen image data storage unit on the basis of the acquisition source information, and
a display controller that displays on the second display device the data of the screen image obtained by the acquisition processing unit.

2. A recording medium storing a program causing a computer contained in an electronic conference system having a display device and a screen image data storage unit to execute a process comprising:
storing, in the screen image data storage unit, a screen image displayed on the display device upon receipt of copy-instructing request from a portable storage device; and
sending acquisition source information regarding data of the screen image displayed on the display device to the portable storage device in accordance with the copy-instructing request from the portable terminal device, to thereby store the acquisition source information in the portable storage device.

3. The recording medium according to claim 2, the process further comprising:
when the portable storage device includes a display, sending to the portable storage device, thumbnail image data corresponding to the data of the screen image displayed on the display device.

4. The recording medium according to claim 2, the process further comprising:
performing data communication with the portable storage device by means of a generated token.

5. A recording medium storing a program causing a computer contained in an electronic conference system having a display device and a screen image data storage unit to execute a process comprising:
receiving acquisition source information stored in a portable storage device connected to a network;
acquiring screen image data from an acquisition source that can be located on the basis of the received acquisition source information, and
displaying the acquired screen image data on the display device.

6. The recording medium according to claim 5, of the process further comprising:
performing data communication with the portable storage device by means of a generated token.

7. The recording medium according to claim 5, of the process further comprising:
issuing a transmission request to a computer which can be located on the basis of the acquisition source information, to thereby acquire the screen image data from the located computer.

8. A recording medium storing a program causing a portable computer equipped with a memory and contained in an electronic conference system having a first conference control apparatus which controls display of a first display device and a second conference control apparatus which controls display of a second display device to execute a process comprising:
receiving acquisition source information regarding screen image data displayed on the first display device sent from the first conference control apparatus, to thereby write and store the acquisition source information in the memory;
sending the acquisition source information stored in the memory to the second conference control apparatus for causing the second conference control apparatus to acquire the screen image data from an acquisition source which can be located on the basis of the acquisition source information.

9. An electronic conference control apparatus in an electronic conference system comprising:
a display;
a screen image data storage unit that stores, a screen image displayed on the display upon receipt of copy-instructing request from a portable storage device; and
an output processing unit that sends acquisition source information regarding the screen image data displayed on the display to the portable storage device, to thereby store the acquisition source information in the portable storage device in accordance with the copy-instructing request from the portable storage device.

10. An electronic conference control apparatus in an electronic conference system comprising:
a display;
a reception unit that receives acquisition source information stored in a portable storage device connected to a network;
an acquisition processing unit that acquires screen image data from an acquisition source which can be located on the basis of the acquisition source information received by the reception unit; and
a display controller that causes the display to display the screen image data acquired by the acquisition processing unit.

11. A portable storage device in an electronic conference system comprising:
a memory;
a copy-processing unit that receives, from a first conference control apparatus, acquisition source information regarding data of a screen image displayed on a first display device owned by the first conference control apparatus, and writes and stores the acquisition source information in the memory; and
a paste processing unit that sends the acquisition source information stored in the memory to a second conference control apparatus for causing the second conference control apparatus to acquire the data of the screen image from an acquisition source which can be located on the basis of the acquisition source information and display the screen image.

12. An electronic conference support method executed by an electronic conference system having a first conference control apparatus that controls display of a first display device, a second conference control apparatus that controls display of a second display device, a portable computer including a memory, and a screen image data storage unit in which screen images displayed at least on the first display device are stored, the method comprising:
storing, in the screen image data storage unit, a screen image displayed on the first display device upon receipt of copy-instructing request from the portable computer, and
sending acquisition source information regarding data of the screen image displayed on the first display device to the portable computer for storing the acquisition source information in the portable computer in accordance with the copy-instructing request from the portable computer;
reading the acquisition source information stored in the portable computer;
acquiring the data of the screen image from an acquisition source which can be located on the basis of the read acquisition source information; and
displaying the acquired data of the screen image on the second display device.

13. A computer data signal embodied in a carrier wave for enabling a computer contained in an electronic conference system having a display device and a screen image data storage unit to perform a process comprising:
storing in the screen image data storage unit a screen image displayed on the display device upon receipt of copy-instructing request information from a portable storage device; and
sending acquisition source information regarding data of the screen image displayed on the display device to the portable storage device for storing the acquisition source information in the portable storage device in accordance with the copy-instructing request information received from the portable storage device.
